(19) United States
(12) Patent Application Publication
(10) Pub. No.: US 2026/0237920 A1
(43) Pub. Date: Aug. 13, 2026

(54) TERMINAL BLOCK

(71) Applicant: Yazaki Corporation, Tokyo (JP)

(72) Inventor: Michihiro MORI, Shizuoka (JP)

(73) Assignee: Yazaki Corporation, Tokyo (JP)

(21) Appl. No.: 19/449,961

(22) Filed: Jan. 15, 2026

(30) Foreign Application Priority Data
Feb. 12, 2025 (JP) 2025-020545

(51) Int. Cl. H01R 9/24; H01F 7/02

(52) U.S. Cl. CPC H01R 9/24; H01F 7/02

(57) ABSTRACT

A terminal block includes a bus bar, a magnetic body including a hole through which the bus bar is inserted, a cover including a main body that holds the magnetic body and a plurality of engagement portions protruding from the main body, and a housing including a cylindrical portion that accommodates the cover and the magnetic body, and a plurality of locking holes that lock the engagement portion, the housing being fixed to a case of a device, in which a cross-sectional shape of the cylindrical portion is a flat shape having a first direction which is a longitudinal direction and a second direction which is a lateral direction.

### CROSS-REFERENCE TO RELATED APPLICATION(S)

The present application claims priority to and incorporates by reference the entire contents of Japanese Patent Application No. 2025-020545 filed in Japan on February 12, 2025.

### BACKGROUND OF THE INVENTION

### Field of the Invention

The present invention relates to a terminal block.

### Description of the Related Art

Conventionally, there is a structure including a bus bar and a magnetic body for removing noise. Japanese Patent Application Laid-open No. 2015-230947 discloses a bus bar holding structure in which a first-phase bus bar, a second-phase bus bar, and a third-phase bus bar are surrounded by a magnetic material.

When a terminal block including a housing for holding a bus bar and a magnetic body surrounding the bus bar is assembled to a case of a device, it is desirable to be able to reduce deterioration of noise removal performance of the magnetic body.

### SUMMARY OF THE INVENTION

An object of the present invention is to provide a terminal block capable of reducing deterioration of noise removal performance of a magnetic body.

A terminal block according to one aspect of the present invention includes a bus bar; a magnetic body including a hole through which the bus bar is inserted; a cover including a main body that holds the magnetic body and a plurality of engagement portions protruding from the main body; and a housing including a cylindrical portion that accommodates the cover and the magnetic body, and a plurality of locking holes that lock the engagement portion, the housing being fixed to a case of a device; wherein a cross-sectional shape of the cylindrical portion is a flat shape having a first direction which is a longitudinal direction and a second direction which is a lateral direction, the cylindrical portion includes a pair of first wall portions facing each other in the first direction and a pair of second wall portions facing each other in the second direction, and the plurality of locking holes include a first locking hole provided in each of the pair of first wall portions and a second locking hole provided in any one of the pair of second wall portions.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to an embodiment;

FIG. 2 is a perspective view of the terminal block according to the embodiment;

FIG. 3 is an exploded perspective view of the terminal block according to the embodiment;

FIG. 4 is a perspective view of a magnetic body according to the embodiment;

FIG. 5 is a plan view of the magnetic body unit according to the embodiment;

FIG. 6 is a perspective view of a housing according to the embodiment;

FIG. 7 is a perspective view of the terminal block according to the embodiment; and

FIG. 8 is a cross-sectional view of the terminal block according to the embodiment.

### DETAILED DESCRIPTION OF THE PREFERRED EMBODIMENTS

Hereinafter, a terminal block according to embodiments of the present invention will be described in detail with reference to the drawings. Note that the present invention is not limited by the embodiments. In addition, constituent elements in the following embodiments include those that can be easily assumed by those skilled in the art or those that are substantially the same.

### Embodiment

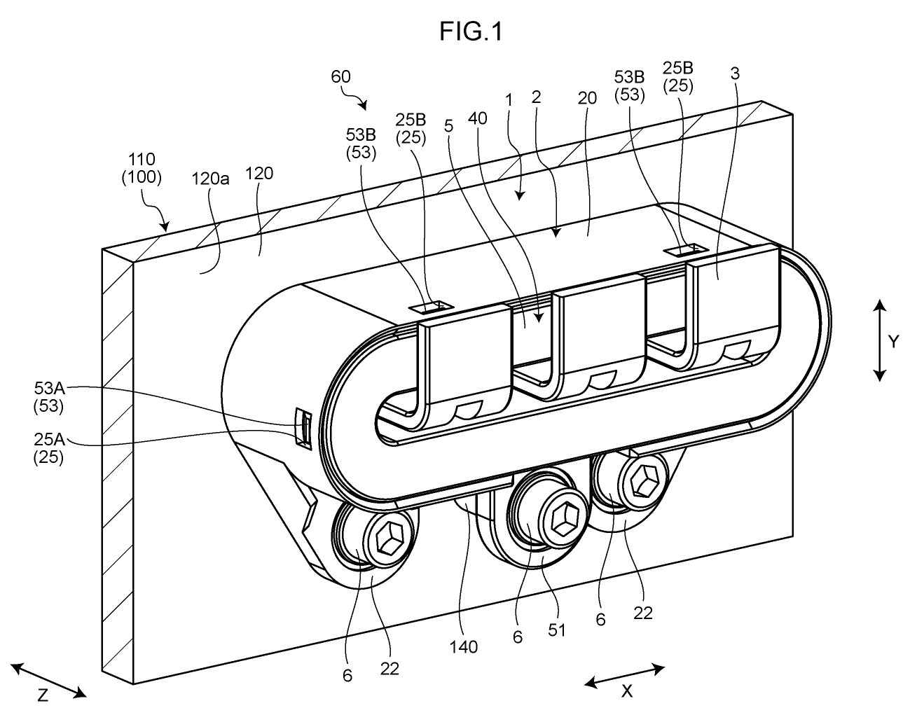

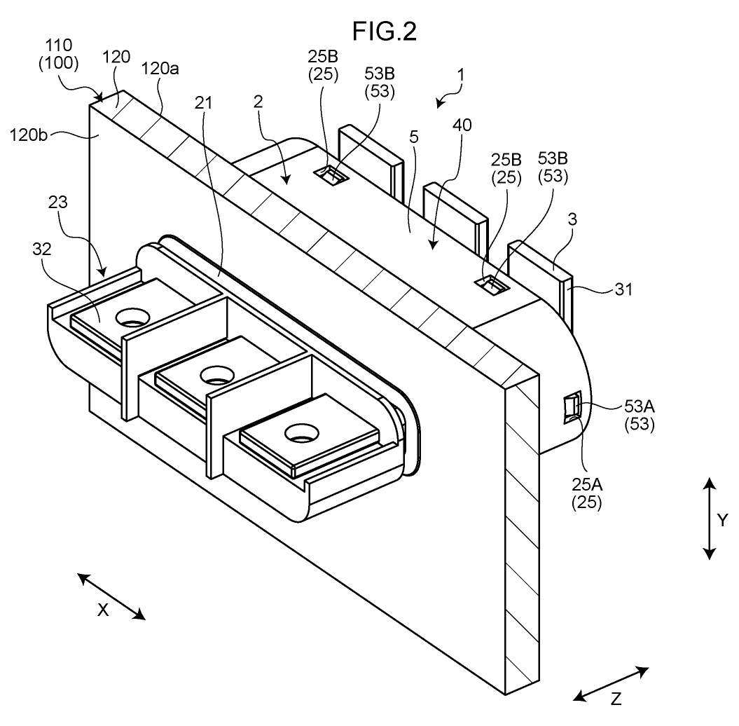

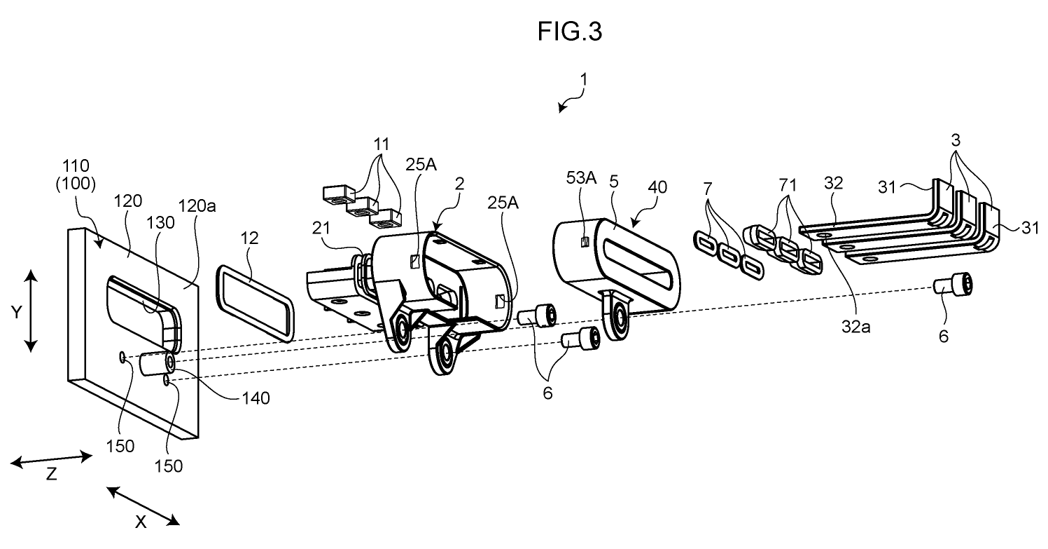

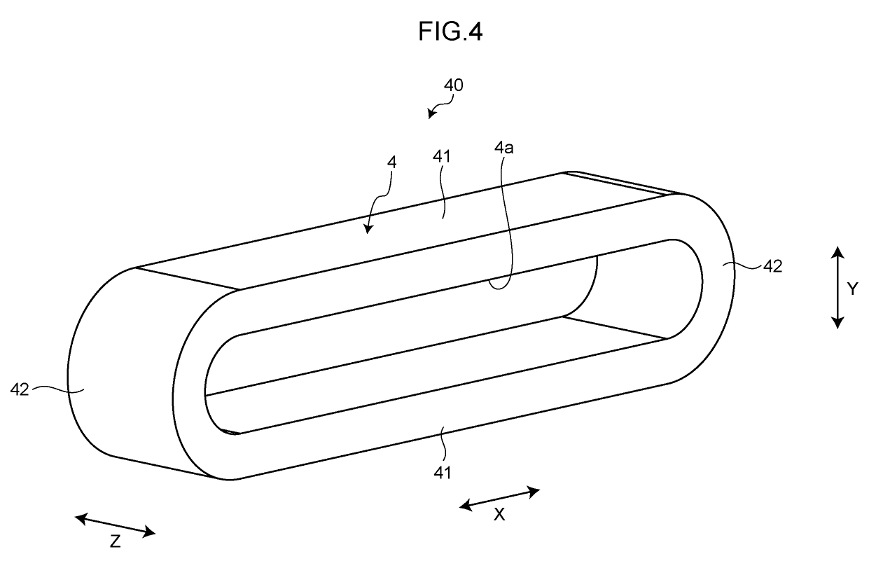

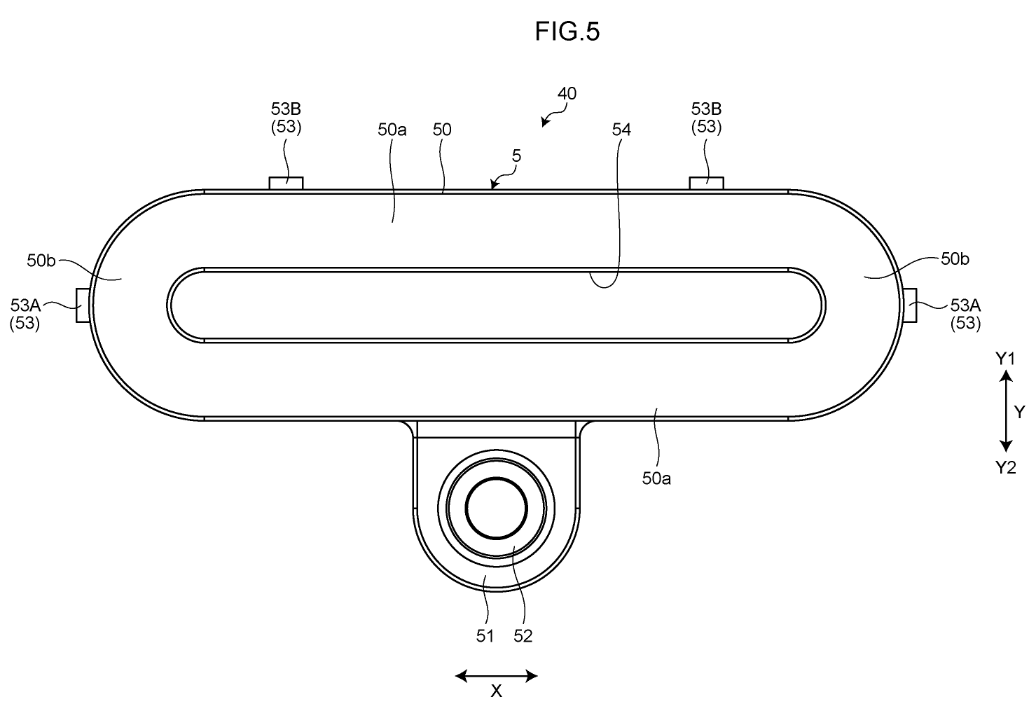

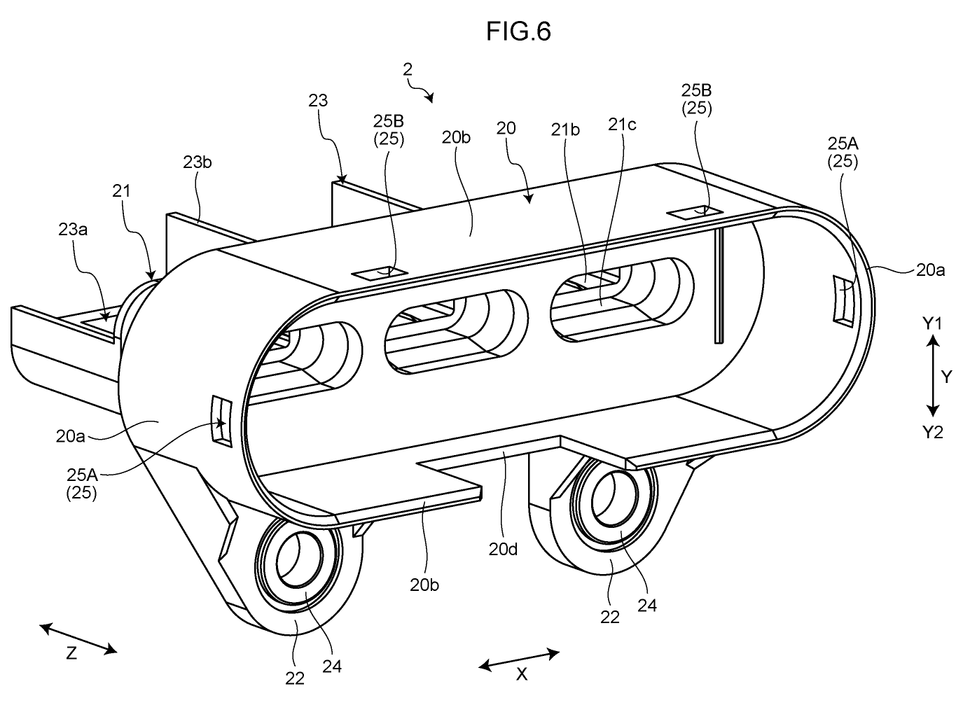

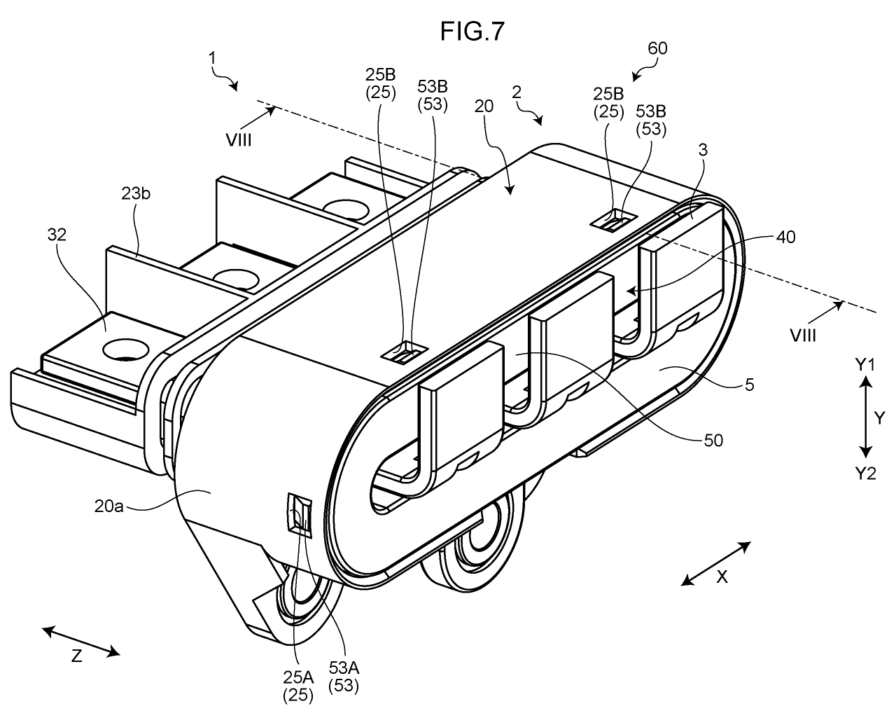

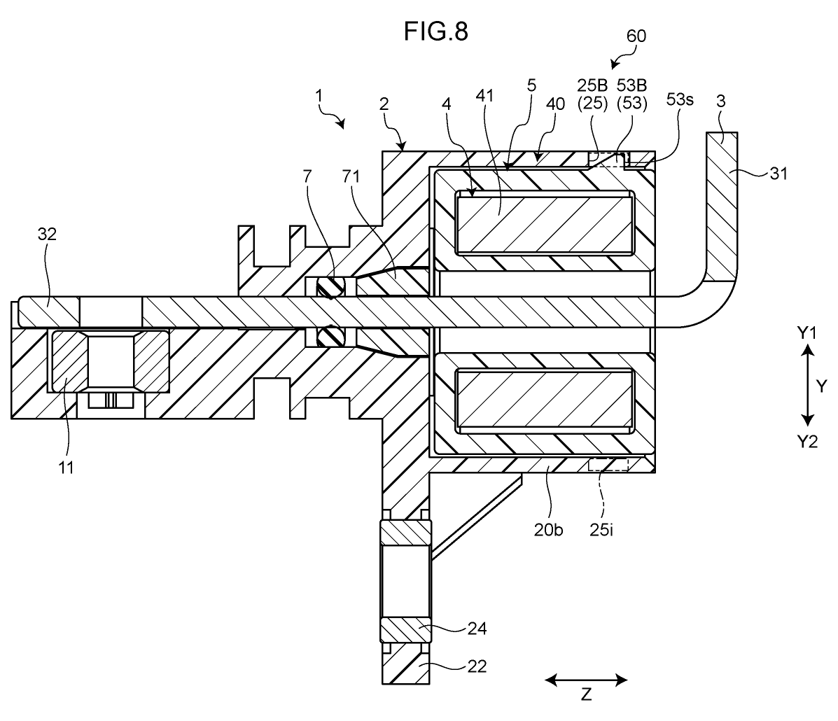

An embodiment will be described with reference to FIGS. 1 to 8. The present embodiment relates to a terminal block. FIGS. 1 and 2 are perspective views of the terminal block according to the embodiment, FIG. 3 is an exploded perspective view of the terminal block according to the embodiment, FIG. 4 is a perspective view of a magnetic body according to the embodiment, FIG. 5 is a plan view of the magnetic body unit according to the embodiment, FIG. 6 is a perspective view of the housing according to the embodiment, FIG. 7 is a perspective view of the terminal block according to the embodiment, and FIG. 8 is a cross-sectional view of the terminal block according to the embodiment. FIG. 8 illustrates a cross section taken along line VIII-VIII in FIG. 7.

As illustrated in FIG. 1, a terminal block 1 of the present embodiment is fixed to a case 110 of a device 100. The device 100 is, for example, a device mounted on a vehicle such as an automobile. The device 100 may be a motor. The case 110 of the device 100 includes a wall portion 120. The wall portion 120 is, for example, an outer wall of the case 110. The terminal block 1 is fixed to the wall portion 120 and supported by the wall portion 120. The terminal block 1 fixed to the case 110 has a first direction X, a second direction Y, and a third direction Z. The first direction X and the second direction Y are orthogonal to each other. The third direction Z is orthogonal to both the first direction X and the second direction Y. The first direction X and the third direction Z are, for example, a front-rear direction of the vehicle and a vehicle width direction. In this case, the second direction Y is a vehicle vertical direction.

The illustrated wall portion 120 is orthogonal to the third direction Z. The wall portion 120 includes a first wall surface 120a facing the outside of the case 110 and a second wall surface 120b facing the inside of the case 110. The first wall surface 120a is a surface along the first direction X and the second direction Y, and is, for example, a flat surface. The terminal block 1 is fixed to the case 110 so as to be in contact with the first wall surface 120a of the wall portion 120.

As illustrated in FIG. 3, a through hole 130 is formed in the wall portion 120 of the case 110. The through hole 130 is opened in each of the first wall surface 120a and the second wall surface 120b. That is, the through hole 130 allows the space portion on one side and the space portion on the other side sandwiching the wall portion 120 to communicate with each other. When the wall portion 120 is the outer wall of the case 110, the through hole 130 allows the external space and the internal space of the case 110 to communicate with each other. A housing 2 includes a fitting portion 21 that fits into the through hole 130.

The terminal block 1 includes the housing 2, a bus bar 3, a magnetic body unit 40, a plurality of fastening members 6, an O-ring 7, a holder 71, a nut 11, and an O-ring 12.

The housing 2 is a member that holds the bus bar 3 and is fixed to the case 110. The housing 2 is molded using, for example, insulating synthetic resin. The housing 2 of the present embodiment holds the magnetic body unit 40 and is fixed to the case 110 in a state where the magnetic body unit 40 is locked. The nut 11 is a fastening member that fixes the bus bar 3 to the terminal of the device 100, and is accommodated in the recess of the housing 2. The O-ring 12 is attached to the fitting portion 21 of the housing 2. The O-ring 12 seals between the fitting portion 21 and the inner wall surface of the through hole 130 of the case 110.

The bus bar 3 is a plate-shaped conductive member, and is formed of a conductive metal plate such as copper. The bus bar 3 includes a first terminal portion 31 and a second terminal portion 32. The first terminal portion 31 is one end portion of the bus bar 3, and the second terminal portion 32 is the other end portion of the bus bar 3. The illustrated bus bar 3 is bent at a right angle between the first terminal portion 31 and the second terminal portion 32. A plate-like portion of the bus bar 3 including the second terminal portion 32 is inserted into the magnetic body unit 40 and the housing 2.

The first terminal portion 31 is connected to a power source side of a battery or the like of the vehicle. The first terminal portion 31 may be connected to the inverter. The second terminal portion 32 is connected to a terminal of the device 100. That is, the bus bar 3 of the present embodiment is interposed between the power supply and the device 100. The illustrated terminal block 1 includes three bus bars 3. The second terminal portion 32 is provided with a through hole 32a into which a bolt can be inserted. The second terminal portion 32 is fastened to the terminal of the device 100 by the nut 11 and a bolt.

The O-ring 7 and the holder 71 are members mounted on the bus bar 3. The O-ring 7 seals between the bus bar 3 and the hole of the housing 2. The holder 71 supports the O-ring 7 and regulates positional deviation and deformation of the O-ring 7. The bus bar 3 is inserted into the housing 2 with the second terminal portion 32 side as a head in a state where the O-ring 7 and the holder 71 are attached. The holder 71 is disposed on the first terminal portion 31 side with respect to the O-ring 7. The holder 71 supports the O-ring 7 and can push the O-ring 7 to a normal position inside the housing 2.

The magnetic body unit 40 includes a magnetic body 4 illustrated in FIG. 4 and a cover 5 illustrated in FIG. 5. The magnetic body 4 is formed of a magnetic body having a noise reduction function. The magnetic body 4 is formed of, for example, ferrite. The magnetic body 4 includes a hole 4a through which the bus bar 3 can be inserted. The magnetic body 4 of the present embodiment is configured such that the three bus bars 3 can be inserted into one hole 4a. The illustrated magnetic body 4 has a cylindrical shape. More specifically, the cross-sectional shape of the magnetic body 4 in the cross section orthogonal to the axial direction of the hole 4a is an oval shape. In a state where the terminal block 1 is fixed to the case 110, the major axis direction of the cross section of the magnetic body 4 is along the first direction, and the minor axis direction of the cross section is along the second direction Y. In addition, the axial direction of the hole 4a is along the third direction Z.

The magnetic body 4 includes a pair of flat plate portions 41 and a pair of arcuate portions 42. The pair of flat plate portions 41 has a flat plate shape and is parallel to each other. In a state where the terminal block 1 is fixed to the case 110, the pair of flat plate portions 41 faces each other in the second direction Y. The arcuate portion 42 has an arcuate shape, and connects an end portion of one flat plate portion 41 and an end portion of another flat plate portion 41. In a state where the terminal block 1 is fixed to the case 110, the pair of arcuate portions 42 faces each other in the first direction X.

As illustrated in FIG. 5, the cover 5 includes a main body 50 that holds the magnetic body 4, and an engagement portion 53 protruding from the main body 50. The cover 5 of the present embodiment further includes a first fixing portion 51 fixed to the case 110. The illustrated cover 5 covers the outer peripheral surface, the inner peripheral surface, and the end surface of the magnetic body 4. The cover 5 is molded using, for example, insulating synthetic resin. The cover 5 of the present embodiment is molded with respect to the magnetic body 4 and is integrated with the magnetic body 4. Therefore, the magnetic body 4 is sealed inside the cover 5.

The magnetic body 4 may be bonded to the cover 5 or press-fitted into the cover 5. In this case, the cover 5 preferably includes an accommodation chamber that accommodates the magnetic body 4. For example, the magnetic body 4 is bonded to the cover 5 in a state of being accommodated in the accommodation chamber of the cover 5, and is held by the cover 5. For example, the magnetic body 4 is press-fitted into an accommodation chamber of the cover 5 and held by the cover 5. The cover 5 may have a lid that closes the accommodation chamber and covers the magnetic body 4.

The main body 50, the first fixing portion 51, and the engagement portion 53 are integrated. The main body 50 has an annular shape and accommodates the magnetic body 4 therein. The shape of the main body 50 in plan view is an oval shape corresponding to the shape of the magnetic body 4. The main body 50 includes a pair of straight portions 50a and a pair of arcuate portions 50b. The straight portion 50a is a portion that covers the flat plate portion 41 of the magnetic body 4 and has a rectangular tube shape. The arcuate portion 50b is a portion that covers the arcuate portion 42 of the magnetic body 4 and has a tubular shape curved in an arcuate shape. The main body 50 includes a hole 54 formed by the pair of straight portions 50a and the pair of arcuate portions 50b. The shape of the hole 54 in plan view is an oval shape corresponding to the shape of the hole 4a. The bus bar 3 is inserted into the hole 54.

The first fixing portion 51 protrudes from the outer peripheral surface of the main body 50. More specifically, the first fixing portion 51 protrudes from the straight portion 50a located on a second side Y2 in the second direction Y. The first fixing portion 51 protrudes toward the side opposite to the side of the other one straight portion 50a. The first fixing portion 51 is disposed at the center of the main body 50 in the first direction X. The position of the first fixing portion 51 in the first direction X is, for example, a gravity center position of the magnetic body 4.

The first fixing portion 51 has a plate shape and holds a collar 52. The collar 52 may be integrated with the first fixing portion 51 by molding, or may be press-fitted into a hole of the first fixing portion 51. The first fixing portion 51 holds the collar 52 such that the axial direction of the collar 52 is along the third direction Z.

The cover 5 of the present embodiment includes a plurality of engagement portions 53. Each of the plurality of engagement portions 53 protrudes from the outer peripheral surface of the main body 50. The engagement portion 53 is inserted into the locking hole 25 of the housing 2 and locked by the locking hole 25. The plurality of engagement portions 53 include a first engagement portion 53A and a second engagement portion 53B.

The first engagement portion 53A is disposed in the arcuate portion 50b and protrudes from the arcuate portion 50b in the first direction X. The illustrated cover 5 includes two first engagement portions 53A. One first engagement portion 53A is disposed in one arcuate portion 50b, and the other first engagement portion 53A is disposed in the other arcuate portion 50b. The illustrated first engagement portion 53A is disposed at a vertex of the arcuate portion 50b in the first direction X.

The second engagement portion 53B is disposed on one of the straight portions 50a and protrudes from the straight portion 50a in the second direction Y. The illustrated cover 5 includes two second engagement portions 53B. The two second engagement portions 53B are provided on the straight portion 50a on a first side Y1 in the second direction Y. The straight portion 50a on the first side Y1 is a straight portion 50a disposed on the side opposite to the first fixing portion 51 side in the pair of straight portions 50a. The second engagement portion 53B protrudes from the straight portion 50a on the first side Y1 toward the first side Y1. The two second engagement portions 53B are disposed at both end portions of the straight portion 50a in the first direction X. In the first direction X, the first fixing portion 51 is positioned between the two second engagement portions 53B. The position of the first fixing portion 51 may be the center of the two second engagement portions 53B in the first direction X.

As illustrated in FIG. 6, the housing 2 includes a cylindrical portion 20, a fitting portion 21, a second fixing portion 22, a support portion 23, and a collar 24. The cylindrical portion 20, the fitting portion 21, the second fixing portion 22, and the support portion 23 are integrated. The cylindrical portion 20 is a portion that accommodates the magnetic body unit 40 and has a tubular shape capable of accommodating the magnetic body unit 40. The shape of the cylindrical portion 20 in plan view is an oval shape. The longitudinal direction of the cylindrical portion 20 in plan view is the first direction X, and the lateral direction is the second direction Y.

The cylindrical portion 20 includes a pair of first wall portions 20a and a pair of second wall portions 20b. The first wall portion 20a is a wall that faces the arcuate portion 50b of the cover 5 and covers the arcuate portion 50b from the outside. The first wall portion 20a has an arcuate plate shape corresponding to the shape of the arcuate portion 50b. The pair of first wall portions 20a faces each other in the first direction X.

The second wall portion 20b is a wall that faces the straight portion 50a of the cover 5 and covers the straight portion 50a from the outside. The second wall portion 20b has a flat plate shape. The pair of second wall portions 20b faces each other in the second direction Y. End portions of the pair of second wall portions 20b are connected to the first wall portion 20a.

The cylindrical portion 20 includes a plurality of locking holes 25 for locking the engagement portion 53 of the cover 5. The locking hole 25 is a through hole penetrating the first wall portion 20a or the second wall portion 20b of the cylindrical portion 20. The plurality of locking holes 25 include first locking holes 25A provided in each of the pair of first wall portions 20a and second locking holes 25B provided in any one of the pair of second wall portions 20b.

The illustrated cylindrical portion 20 includes two first locking holes 25A. One first locking hole 25A is disposed in one first wall portion 20a, and the other first locking hole 25A is disposed in the other first wall portion 20a. The first locking hole 25A penetrates the first wall portion 20a along the first direction X. The illustrated first locking hole 25A is disposed at a vertex of the first wall portion 20a in the first direction X.

The cylindrical portion 20 of the present embodiment includes two second locking holes 25B. The two second locking holes 25B are disposed in any one of the second wall portions 20b. In the exemplified cylindrical portion 20, two second locking holes 25B are disposed in the second wall portion 20b on the first side Y1 in the second direction Y. The second locking hole 25B penetrates the second wall portion 20b along the second direction Y. The two second locking holes 25B are disposed at both end portions of the second wall portion 20b in the first direction X.

The second wall portion 20b on the second side Y2 is provided with a notch 20d. The notch 20d is provided at a position corresponding to the first fixing portion 51 of the cover 5. The shape of the notch 20d is, for example, a rectangle. The illustrated notch 20d is disposed at the center of the second wall portion 20b in the first direction X. In the first direction X, the two second locking holes 25B are disposed on both sides with respect to the notch 20d.

The fitting portion 21 is a portion fitted into the through hole 130 of the case 110. The fitting portion 21 protrudes from the cylindrical portion 20 in the third direction Z. The shape of the fitting portion 21 is a tubular shape or a rectangular parallelepiped shape having a substantially rectangular cross-sectional shape. An annular recess to which the O-ring 12 is mounted is provided on an outer peripheral surface of the fitting portion 21. The housing 2 is supported by the case 110 by fitting the fitting portion 21 into the through hole 130.

As illustrated in FIG. 6, the fitting portion 21 is provided with a through hole 21b and a recess 21c. The recess 21c is an accommodation chamber that accommodates the O-ring 7, and opens toward the internal space of the cylindrical portion 20. The recess 21c extends in the third direction Z. The shape of the recess 21c in plan view of the housing 2 is an oval shape. The through hole 21b is a hole through which the bus bar 3 is inserted, and is opened at the bottom of the recess 21c. The through hole 21b penetrates the fitting portion 21 toward the support portion 23.

The fitting portion 21 is provided with through holes 21b and recesses 21c in a number corresponding to the number of bus bars 3. The housing 2 of the present embodiment includes three recesses 21c and through holes 21b arranged in the first direction X. The through hole 21b is a holding portion that holds the bus bar 3 inserted into the through hole 21b. A rib for holding the bus bar 3 is disposed in the through hole 21b.

The support portion 23 is a portion that supports the nut 11. The support portion 23 protrudes from the fitting portion 21 in the third direction Z. The support portion 23 includes a plurality of recesses 23a and a plurality of partition walls 23b. The recess 23a accommodates the nut 11 and holds the nut 11. The recess 23a is open toward the first side Y1 in the second direction Y. The recess 23a holds the nut 11 such that the central axis of the nut 11 is along the second direction Y.

The support portion 23 includes the number of recesses 23a corresponding to the number of the bus bars 3. The housing 2 of the present embodiment includes three recesses 23a arranged in the first direction X. The partition wall 23b partitions between two adjacent recesses 23a. In addition, the partition wall 23b extends so as to partition the plurality of bus bars 3 protruding from the fitting portion 21.

The second fixing portion 22 protrudes from a boundary portion between the cylindrical portion 20 and the fitting portion 21. The second fixing portion 22 protrudes from the second wall portion 20b on the second side Y2 of the cylindrical portion 20 toward the second side Y2. The second fixing portion 22 has a plate shape and holds the collar 24. The collar 24 may be integrated with the second fixing portion 22 by molding, or may be press-fitted into a hole of the second fixing portion 22. The second fixing portion 22 holds the collar 24 such that the axial direction of the collar 24 is along the third direction Z.

FIG. 7 illustrates the terminal block 1 before being attached to the case 110 of the device 100. The magnetic body unit 40 is inserted into the cylindrical portion 20 of the housing 2 and accommodated in the cylindrical portion 20. The first engagement portion 53A of the cover 5 is inserted into the first locking hole 25A of the cylindrical portion 20 in the first direction X and locked by the first locking hole 25A. The second engagement portion 53B of the cover 5 is inserted into the second locking hole 25B of the cylindrical portion 20 in the second direction Y and locked by the second locking hole 25B. That is, the housing 2 and the magnetic body unit 40 are fixed to each other by a locking structure 60 configured by the locking hole 25 and the engagement portion 53.

The locking structure 60 functions as a mechanism for temporarily locking the magnetic body unit 40 to the housing 2. That is, the locking structure 60 can fix the housing 2 and the magnetic body unit 40 to each other during conveyance or assembly work until the terminal block 1 is fixed to the case 110. The locking structure 60 can protect the magnetic body unit 40 by preventing the magnetic body unit 40 from falling off from the housing 2.

FIG. 8 illustrates a cross section of the terminal block 1 before being attached to the case 110 of the device 100. The engagement portion 53 includes a facing surface 53s locked by the locking hole 25. The facing surface 53s faces the wall surface of the locking hole 25 in the third direction Z and is locked by the locking hole 25.

As illustrated in FIG. 1, the terminal block 1 is fixed to the case 110 of the device 100 by a plurality of fastening members 6. The illustrated fastening member 6 is a bolt. The fitting portion 21 of the housing 2 is fitted into the through hole 130 of the case 110 and held by the through hole 130. Thus, the terminal block 1 including the magnetic body unit 40 is supported by the case 110. From this state, each fastening member 6 is screwed into screw portions 140 and 150 of the case 110. The first fixing portion 51 of the cover 5 is fixed to the columnar screw portion 140 of the case 110 by the fastening member 6. The second fixing portion 22 of the housing 2 is fixed to the first wall surface 120a of the case 110 by the fastening member 6.

The locking structure 60 regulates relative movement between the housing 2 and the magnetic body unit 40 in the first direction X, the second direction Y, and the third direction Z. Since the relative movement between the housing 2 and the magnetic body unit 40 is regulated, a decrease in the noise removal effect due to the positional deviation of the magnetic body 4 is reduced. In the terminal block 1 of the present embodiment, the housing 2 and the magnetic body unit 40 are assembled to the case 110 in a state of being fixed to each other. As a result, the magnetic body unit 40 is positioned at a normal position with respect to the device 100.

In addition, the locking structure 60 can regulate the movement of the magnetic body unit 40 when the fastening member 6 is screwed. For example, the locking structure 60 can regulate the movement of the magnetic body unit 40 along the first direction X, the second direction Y, and the third direction Z.

In addition, the locking structure 60 can regulate the inclination of the magnetic body unit 40. The first engagement portion 53A and the first locking hole 25A fix both end portions of the magnetic body unit 40 in the longitudinal direction, and regulate the inclination of the magnetic body unit 40 with respect to the first direction X. As a result, the inclination of the magnetic body unit 40 with respect to the housing 2 and the bus bar 3 is effectively regulated. When the fastening member 6 corresponding to the first fixing portion 51 is screwed into the case 110, the first fixing portion 51 receives rotational torque from the fastening member 6. The first engagement portion 53A and the first locking hole 25A support the magnetic body unit 40 against the torque, and can regulate the rotation of the magnetic body unit 40. Similarly, the second engagement portion 53B and the second locking hole 25B can regulate the rotation of the magnetic body unit 40 at the time of fastening.

The second locking hole 25B of the present embodiment is disposed on the side opposite to the sides of the fixing portions 51 and 22 with respect to the magnetic body 4 of the magnetic body unit 40. That is, the fixing portions 51 and 22 and the second locking hole 25B are arranged on different sides in the second direction Y with the magnetic body 4 interposed therebetween. With such an arrangement, both sides in the second direction Y are fixed to the magnetic body 4. Therefore, positional deviation and inclination of the magnetic body 4 are effectively reduced.

According to the terminal block 1 of the present embodiment, the manufacturing cost of the housing 2 can be reduced. In the terminal block 1 of the present embodiment, the second locking hole 25B is disposed in one of the pair of second wall portions 20b. The second wall portion 20b including the second locking hole 25B is positioned on the first side Y1. In other words, the second wall portion 20b including the second locking hole 25B is positioned on the side far from the second fixing portion 22. Therefore, as described below, the processing cost of the mold for molding the housing 2 is reduced.

An assumed position 25i illustrated in FIG. 8 is a position assumed when the locking hole 25 is to be provided in the second wall portion 20b on the second side Y2. In this case, it is necessary to process the pin for holding the collar 24 with a hole or the like so that the pin for holding the collar 24 and the pin for forming the locking hole 25 at the assumed position 25i do not interfere with each other in the mold. On the other hand, in the terminal block 1 of the present embodiment, such processing on the pin becomes unnecessary, and the processing cost can be reduced.

As described above, the terminal block 1 of the present embodiment includes the bus bar 3, the magnetic body 4 including the hole 4a through which the bus bar 3 is inserted, the cover 5, and the housing 2. The cover 5 includes the main body 50 that holds the magnetic body 4, and the plurality of engagement portions 53 protruding from the main body 50. The housing 2 includes the cylindrical portion 20 that accommodates the cover 5 and the magnetic body 4, and the plurality of locking holes 25 that lock the engagement portion 53, and is fixed to the case 110 of the device 100.

The cross-sectional shape of the cylindrical portion 20 is a flat shape having the first direction X which is a longitudinal direction and the second direction Y which is a lateral direction. The cylindrical portion 20 includes the pair of first wall portions 20a facing each other in the first direction X and the pair of second wall portions 20b facing each other in the second direction Y. The plurality of locking holes 25 include first locking holes 25A provided in each of the pair of first wall portions 20a and second locking holes 25B provided in any one of the pair of second wall portions 20b. According to the terminal block 1 of the present embodiment, the housing 2 and the magnetic body 4 are fixed to each other by the locking structure 60 including the engagement portion 53 and the locking hole 25. Therefore, deterioration of noise removal performance of the magnetic body 4 is reduced.

The cover 5 of the present embodiment includes the first fixing portion 51 fixed to the case 110 by the fastening member 6. The housing 2 includes the second fixing portion 22 fixed to the case 110 by the fastening member 6. Since the magnetic body 4 is positioned by the locking structure 60 and the cover 5 and the housing 2 are fixed to the case 110 by the fastening member 6, deterioration of noise removal performance of the magnetic body 4 is reduced.

The contents disclosed in the above embodiments can be appropriately combined and executed.

In the terminal block according to the present embodiment, the cylindrical portion of the housing includes a pair of first wall portions facing each other in a first direction and a pair of second wall portions facing each other in a second direction, and the plurality of locking holes include first locking holes provided in the pair of first wall portions and second locking holes provided in any one of the pair of second wall portions. According to the terminal block of the present embodiment, when the housing and the magnetic body are engaged with each other, it is possible to reduce deterioration of noise removal performance of the magnetic body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar;
a magnetic body including a hole through which the bus bar is inserted;
a cover including a main body that holds the magnetic body and a plurality of engagement portions protruding from the main body; and
a housing including a cylindrical portion that accommodates the cover and the magnetic body, and a plurality of locking holes that lock the engagement portion, the housing being fixed to a case of a device; wherein
a cross-sectional shape of the cylindrical portion is a flat shape having a first direction which is a longitudinal direction and a second direction which is a lateral direction,
the cylindrical portion includes a pair of first wall portions facing each other in the first direction and a pair of second wall portions facing each other in the second direction, and
the plurality of locking holes include a first locking hole provided in each of the pair of first wall portions and a second locking hole provided in any one of the pair of second wall portions.

2. The terminal block according to claim 1, wherein
the cover includes a first fixing portion fixed to the case by a fastening member, and
the housing includes a second fixing portion fixed to the case by a fastening member.
